(19) United States
(12) Patent Application Publication
(10) Pub. No.: US 2023/0296965 A1
(43) Pub. Date: Sep. 21, 2023

(54) METHOD AND DEVICE FOR UNDERWATER IMAGING

(71) Applicant: I2S, Pessac Cedex (FR)

(72) Inventors: Jules GUILLIEN, Tours (FR); Arnaud TULLIO, L'Haye-les-Roses (FR)

(21) Appl. No.: 18/006,635

(22) PCT Filed: Jul. 8, 2021
(86) PCT No.: PCT/EP2021/068976

§ 371 Date: Jan. 24, 2023

(30) Foreign Application Priority Data
Jul. 30, 2020 (FR) FR2008098

(51) Int. Cl. G03B 17/08; G01J 4/04; H04N 23/84; H04N 23/12; H04N 23/66; G06T 5/00

(52) U.S. Cl. CPC G03B 17/08; G01J 4/04; H04N 23/84; H04N 23/12; H04N 23/66; G06T 5/003; G06T 2207/10152

(57) ABSTRACT

A method for underwater imaging, including the following steps:
acquiring, by a polarimetric image sensor, an image made up of pixels, the acquired image including a backscattered veil for at least a portion of the pixels, the acquired image including at least four sub-images, acquired simultaneously, corresponding to at least four different polarizations,
calculating Stokes parameters based on the luminous intensities of the pixels of the acquired image,
determining, based on the Stokes parameters, an angle of polarization of the backscattered veil,
determining, based on the Stokes parameters, a degree of polarization of the backscattered veil,
calculating the luminous intensity of the backscattered veil based on the angle and the degree of polarization of the backscattered veil, and
calculating, based on the acquired image and the luminous intensity of the backscattered veil, an improved image,
   the method being implemented by means of a device for underwater imaging.

### TECHNICAL FIELD

The present invention relates to a method for polarized underwater imaging. The invention also relates to a device for underwater imaging implementing such a method.

The field of the invention is non-limitatively that of underwater imaging. More particularly, but non-limitatively, the field of the invention is that of underwater inspections in turbid water.

### STATE OF THE ART

When images of scenes are taken in diffusive media, such as smoke, fog or turbid water, their contrast and their brightness can be deteriorated by the presence of particles suspended in these media.

In particular, the quality of the image in turbid media can be degraded by two components:
light reflected by the natural scene, partially absorbed by the particles in suspension,
undesirable light diffused by the particles, generally called “airtight” for images taken in air. This diffused light leads to a veil which causes the contrast of the image to deteriorate.

During the processing of the images, it is then important to be able to determine, with precision, the intensity and the colour of the diffused light in order to increase the visibility.

Numerous methods for restoring images in diffusive media have been developed in order to eliminate the veil. These methods, called dehazing methods, are based on the acquisition of several images of one and the same scene for several different polarizations of the captured light.

Polarimetric imaging is in particular known in underwater photography, by utilizing two different polarizations.

Generally, systems implementing these methods require manipulation of a polarization analyzer between the different image captures, as well as artificial lighting, polarized or not, of the underwater scene. The processing methods are also relatively long, depending on the size of the images acquired. Thus, the known dehazing methods are not suitable for processing images in real time, for example for video.

### DISCLOSURE OF THE INVENTION

The aim of the present invention is to have available a method and a device for underwater imaging which make it possible to overcome the drawbacks mentioned.

A subject of the present invention is to propose a method and a device for underwater imaging which make it possible to obtain clear and high-contrast underwater images in real time in all types of water.

This aim is achieved with a method for underwater imaging, comprising the following steps:
acquiring, by a polarimetric image sensor, an image made up of pixels, the acquired image comprising a backscattered veil for at least a portion of the pixels, the acquired image comprising at least four sub-images, acquired simultaneously, corresponding to at least four different polarizations,
calculating Stokes parameters based on the luminous intensities of the pixels of the acquired image,
determining, based on the Stokes parameters, an angle of polarization of the backscattered veil,
determining, based on the Stokes parameters, a degree of polarization of the backscattered veil,
calculating the luminous intensity of the backscattered veil based on the angle and the degree of polarization of the backscattered veil, and
calculating, based on the acquired image and the luminous intensity of the backscattered veil, an improved image,
   the method being implemented by means of a device for underwater imaging.

The method for underwater imaging makes it possible to improve the quality of the images acquired under water. The method implements a polarimetric acquisition and processing of the images, the processing being based on the analysis of the distribution of the angle of polarization of the captured light. This analysis makes it possible to identify the luminous intensity originating from the diffusion by the suspended particles and thus to eliminate it.

The method according to the invention does not utilize any artificial lighting of the scene to be imaged. Thus, only sunlight lights the scene. Solar light is a light called non-polarized light. However, according to Snell-Descartes' and Maxwell's laws, the effect of the air-water interface is to partially polarize it. The angle of polarization of the light depends on the position of the sun in the sky. In all cases, the light is sufficiently polarized after it passes through the air-water interface. Light is also partially polarized when it is diffused by particles suspended in the water. Partial polarization, due to these two phenomena, of the diffused light makes it possible to apply the processing steps of the method according to the invention.

The acquired image comprises at least four sub-images corresponding to at least four different polarizations. The sub-images are then acquired simultaneously, their acquisition not requiring any analyzer manipulation or adjustment. Each sub-image represents the scene completely as the acquired image itself.

The step of calculating Stokes parameters, and thus all the other processing steps of the method according to the invention, is carried out based on the luminous intensities of the pixels of the acquired image. This means that the whole image, with all the pixels, can be used to perform this calculation. In fact, no area or region of the image is chosen beforehand.

By virtue of the polarimetric and simultaneous acquisition, combined with the processing of the whole surface of the image, the method according to the invention can be implemented in real time, in particular for video.

Hereinafter, the term “underwater” should be understood to denote “under water” in general, the method and the device according to the invention being suitable for use in an undersea environment, but of course equally in a lake, a stream, a river, etc.

According to an advantageous embodiment, the polarizations can be linear and correspond to 0°, 45°, 90° and 135°.

According to an alternative embodiment, two of the polarizations can be linear and the other two left-hand and right-hand circular polarizations.

According to an embodiment, the step of determining an angle of polarization can be carried out by:
drawing up a map of angle of polarization values based on the Stokes parameters, and
determining the most represented angle of polarization value, called angle of polarization of the veil, in the acquired image based on the map of angle values.

Similarly, the step of determining a degree of polarization can be carried out by:
drawing up a map of degree of polarization values based on the Stokes parameters,
determining the most represented degree of polarization value, called degree of polarization of the veil, in the acquired image based on the map of degree values.

According to an embodiment, the method can also comprise a step of estimating the luminous intensity of the backscattered veil at infinity.

In fact, it can be assumed that at infinity, the backscattered veil is entirely due to the suspended particles having a defined polarization. The luminous intensity at infinity therefore constitutes a reference for the state and the nature (polarization, colour) of the veil of particles. Thus, it is possible to estimate the percentage of backscattering which is present in front of the imaged scene or object and which it is desired to eliminate without needing information on the distance from the object or scene.

According to an embodiment, the step of estimating the luminous intensity of the backscattered veil at infinity can be carried out by:
drawing up a map of luminous intensity values based on the angle and the degree of polarization of the backscattered veil,
determining the most represented intensity value, called luminous intensity at infinity, in the acquired image based on the map of intensity values.

According to an embodiment, the step of calculating the luminous intensity of the backscattered veil can comprise a step of calculating the average of the luminous intensities of the backscattered veil of all the sub-images.

Advantageously, the step of calculating Stokes parameters is carried out by averaging the Stokes parameters over a number n of adjacent pixels, with n=4 . . . 8, for example.

This step makes it possible to have a restored image the adjacent intensity values of which do not differ too much, in order thus to avoid digital artifacts.

Advantageously, all the image processing steps can be carried out independently for each colour channel R, G and B.

This takes into account the fact that in an underwater environment, the intensity of the light is attenuated depending on its wavelength and the distance covered in the water.

According to another aspect of the same invention, a device for underwater imaging is proposed, comprising:
at least one polarimetric image sensor comprising:
   a plurality of elementary sensors,
   a matrix of polarization analyzers arranged so that each elementary sensor is equipped with an analyzer, each analyzer being oriented according to one of at least four different polarizations so that the orientations of the analyzers are distributed in a homogeneous manner over the surface of the sensor,
the polarimetric image sensor being configured to acquire an image comprising at least four sub-images, acquired simultaneously, corresponding to the at least four different polarizations; and
an image processing module.
   The device is configured to implement the steps of the method according to the invention.

Advantageously, the device is configured to be adaptable on a remotely operated underwater vehicle (ROV) or autonomous underwater vehicle.

This type of underwater vehicle makes it possible, for example, to perform inspections of dams, vats, boat hulls, pipelines, or, more broadly, any inspections of installations that are partially or totally submerged in water. They also make it possible to carry out underwater work at depths or in places where humans cannot go. The areas of application are in particular the following: constructions, dams, marine renewable energies, drilling, the inspection, maintenance and repair of structures, telecomms, the petroleum and gas industry, the dismantling of platforms, the nuclear industry and defence.

Alternatively, the device according to the invention can be carried directly by divers.

According to yet another aspect of the same invention, a computer program is proposed, comprising instructions which lead the device for underwater imaging according to the invention to execute the steps of the method for underwater imaging according to the invention.

According to yet another aspect, the invention relates to a computer-readable data medium on which the computer program according to the invention is recorded.

### DESCRIPTION OF THE FIGURES AND EMBODIMENTS

Other advantages and characteristics will become apparent on examining the detailed description of examples that are in no way limitative, and from the attached drawings, in which:

FIG. 1 is a diagrammatic representation of a non-limitative embodiment example of a device for underwater imaging according to the invention;

FIG. 2 is a diagrammatic representation of an example optical sensor capable of being used in the device according to the present invention;

FIG. 3 is a diagrammatic representation of a non-limitative embodiment example of a method for underwater imaging according to the present invention;

FIG. 4 is an example acquired image according to the present invention; and

FIG. 5 illustrates steps of the method of the invention according to an embodiment example.

It is well understood that the embodiments that will be described hereinafter are in no way limitative. Variants of the invention can in particular be envisaged comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together if there is no objection to this combination from a technical point of view.

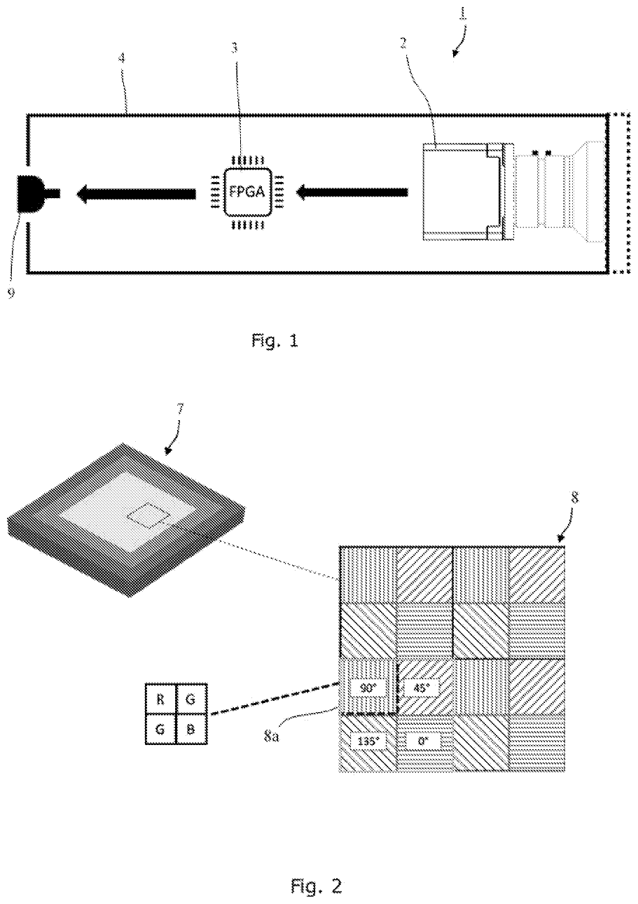

FIG. 1 is a diagrammatic representation of a non-limitative embodiment example of a device for underwater imaging capable of being utilized in the context of the present invention. The device can in particular be used for implementing the method of the invention.

The device 1, represented in FIG. 1, comprises a digital camera 2 placed in a waterproof box 5 with an electronic processing board 4. The camera 2 comprises an objective lens 3. The camera 2 is arranged so that the objective lens 3 is positioned opposite a transparent porthole 6 of the box 5.

The camera 2 is equipped with a polarimetric sensor, such as illustrated in FIG. 2. The sensor 7 is composed of a matrix sensor of the CMOS type, having a plurality of elementary sensors, and an analyzer matrix 8 having a plurality of analyzers 8a. Each elementary sensor is associated with an analyzer 8a.

FIG. 2 shows a portion of the polarimetric sensor 7, likewise diagrammatically. As is suggested by hatching in FIG. 2, a polarizing filter in the form of a diffraction grating can be placed on each elementary sensor. A microlens can be placed on each filter.

As shown in FIG. 1, the box 5 also comprises a waterproof connector 9 allowing a transmission cable to be connected in order to transmit, in real time, the data from the electronic board 4 to a distant piece of equipment, for example on land or a boat, from which an ROV carrying the device 1 can be piloted using the camera 2.

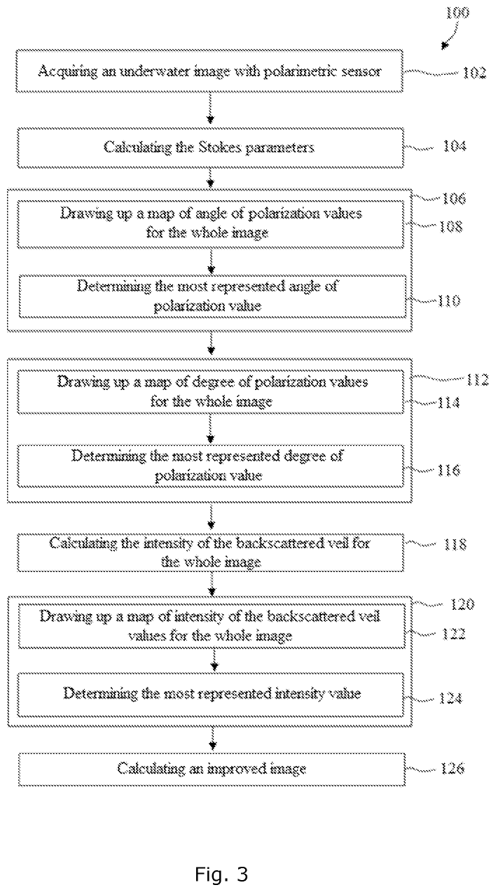

FIG. 3 is a diagrammatic representation of a non-limitative embodiment example of a method for underwater imaging according to the invention.

The method 100, represented in FIG. 3, comprises a step 102 of acquiring an underwater image. This step 102 can be carried out, for example, by a polarimetric image sensor as described with reference to FIGS. 1 and 2. The acquired image comprises a backscattered veil for at least a portion of the pixels.

By virtue of the nature of the polarimetric sensor, the acquired image comprises at least four sub-images corresponding to at least four different polarizations of the captured light.

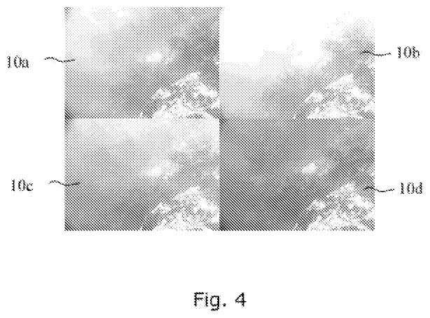

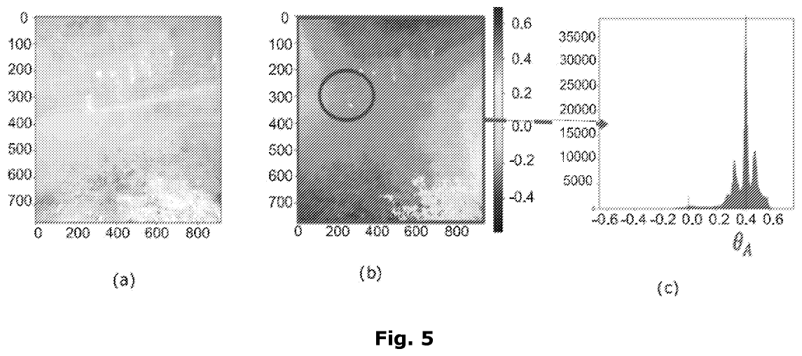

By way of example, these polarizations are of 0°, 45°, 90° and 135°. An example of four sub-images 10a, 10b, 10c, 10d with these polarizations is given in FIG. 4.

In a turbid medium, the intensity I received by the sensor is composed of the intensity reflected by the scene through the veil of particles, denoted D, and the intensity of the backscattered veil, i.e. that reflected by the particles in suspension, denoted A. The component A is partially polarized. I can be expressed by:

I=D+A, [Math1]

where D and A can be respectively expressed by the following relationships:

D=Lt(z), [Math2]

A=A_{inf}[1−t(z)]. [Math3]

L represents the intensity of the light without having been attenuated by the veil of particles, A_{inf} the intensity of the backscattered veil for an imaginary object situated at infinity and t(z) the transmittance of the water. By assuming that the extinction coefficient β does not vary with the distance z, whatever the nature of the water in which the image is taken, t(z) can be expressed by:

t(z)=e^{-βz}. [Math4]

With the aid of the preceding equations, L can be expressed by:

$$L = \frac{I - A}{1 - A / {A}_{inf}} . \qquad [ Math5 ]$$

During a step 104, Stokes parameters are calculated for each of the pixels of the acquired image based on the luminous intensities I captured. The Stokes parameters are necessary in order to calculate the intensity A, the angle of polarization (AOP) θ_{A} and the degree of polarization (DOP) p_{A} of the backscattered veil.

For four images corresponding to the polarizations of 0°, 45°, 90° and 135°, the Stokes parameters S₀, S₁ and S₂ are calculated as follows:

S₀=I₀+I₉₀, [Math6]

S₁=I₀−I₉₀l, [Math7]

S₁=I₄₅−I₁₃₅, [Math8]

where S₀ represents the total intensity of the incident light, and S₁ and S₂ represent the polarization states of the light incident on the sensor.

It should be noted that with the aid of the equation [Math6], S₀ is calculated by using only two of the four sub-images, thus allowing this step to be made quicker. This is possible by using the projections of the polarizations 45° and 135° along 0° and 90°.

According to [Math6-8], it is possible to obtain the angle of polarization θ and the degree of polarization p of the incident light according to the following relationships:

$$θ = \frac{1}{2} arctan \frac{{S}_{2}}{{S}_{1}} , \qquad [ Math9 ]$$

$$p = \frac{\sqrt{{S}_{1}^{2} + {S}_{2}^{2}}}{{S}_{0}} . \qquad [ Math10 ]$$

As the method according to the invention does not utilize artificial lighting, it is based solely on the polarization of the natural incident light by passing through air-water and by the particles in suspension. These particles therefore reflect a polarized light.

During a step 106 of the method 100, the angle of polarization θ_{A} of the backscattered veil is determined based on the Stokes parameters. For the embodiment of the method represented in FIG. 3, the step 106 is carried out as follows.

Since an underwater environment, called turbid environment, is strongly loaded with particles, it is possible to assume that in order to estimate the AOP of the veil of particles θ_{A}, it is sufficient to determine the most represented value of θ in the image. It can in particular be assumed that, statistically, the angle of polarization of the veil of particles is the most represented in the image, even if the focus is on the whole image and not just an area of veil. In fact, by comparing the histograms of angles of polarization for the area of veil and for the whole image, for a plurality of images of different scenes, it may be noted that the maximum is substantially at the same angle value in both cases.

Thus, during a step 108, a map of angle of polarization θ values based on the Stokes parameters is drawn up for the acquired image.

Then, during a step 110, the most represented angle of polarization value is determined. Based on the map of values, a histogram of angle of polarization values is calculated, then the maximum value θ_{A} of the histogram is retrieved.

FIG. 5 illustrates the steps of determining the angle of polarization of the veil of particles. FIG. 5(a) shows an image taken in water, unprocessed. FIG. 5(b) shows the map of angle of polarization values that are present in the image. The circle corresponds to an area, called area “of veil”, i.e. without an object to be imaged. Finally, FIG. 5(c) shows the histogram of the angle values for the whole scene as well as the maximum value, corresponding to the angle θ_{A}.

During a step 112 of the method 100, the degree of polarization p of the backscattered veil is determined based on the Stokes parameters. This step 112 makes it possible to know the percentage of the intensity received by the sensor that is in the polarization state θ_{A}. According to the embodiment represented in FIG. 3, the step 112 is carried out in the same way as the step 106 of determining the angle of polarization.

Thus, during a step 114, a map of degree of polarization p values based on the Stokes parameters is drawn up for the acquired image.

Then, during a step 116, the most represented degree of polarization p_{A} value is determined based on the histogram of values.

During a step 118, the luminous intensity A of the backscattered veil is calculated based on the angle θ_{A} and the degree p_{A} of polarization of the backscattered veil, according to the following relationship:

$$A = \frac{2 {I}_{0}}{1 + {p}_{A} cos 2 {θ}_{A}} . \qquad [ Math11 ]$$

According to a particularly advantageous embodiment, the calculation of the intensity of the veil A can be carried out as follows:

$$A = \frac{\frac{1}{2} ( {I}_{0} + {I}_{45} + {I}_{90} + {I}_{135} )}{1 + {p}_{A} cos 2 {θ}_{A}} . \qquad [ Math12 ]$$

This amounts to estimating A for each of the four sub-images I₀, I₄₅, I₉₀ and I₁₃₅ corresponding to the four polarizations, and averaging these four values of A in order to find the final value of A.

This embodiment makes it possible to further improve the quality of the image restoration and in particular to reduce colour jumps in the restored image.

Based on A, it is possible to estimate the intensity A_{inf} of the backscattered veil at infinity. According to the embodiment represented in FIG. 3, this step 120 is carried out in the same way as the steps 106 and 112 of determining the angle and the degree of polarization, respectively.

Thus, during a step 122, a map of luminous intensity values is drawn up for the whole acquired image.

Then, during a step 124, the most represented luminous intensity value, called intensity of the veil at infinity A_{inf}, is determined based on the histogram of values.

All the parameters going into the calculation of an improved, or restored, image were determined in this way (see [Math5]).

According to an embodiment, in order to make the image processing automatic and more successful, correction factors are introduced into the relationship [Math5]. This makes it possible to avoid aberrations in the calculation of L if A is very close to A_{inf}.

Firstly, a coefficient a is introduced into the equation [Math5]:

$$L = \frac{I - A}{1 - α A / {A}_{inf}} . \qquad [ Math13 ]$$

This coefficient is an adjustable parameter comprised between 0 and 1. Advantageously, the value of 0.5 is chosen because it gives good results in tests in different types of water. In fact, for an automatic processing, it is not possible to envisage determining the parameter α for each new image acquired. The value of 0.5 allows the image processing not to be deteriorated while avoiding digital artifacts.

Secondly, a normalized intensity Aₙₒᵣₘ of the backscattered veil is introduced into the equation [Math5]:

$${A}_{n o r m} = \frac{1}{2} \frac{A}{max \frac{A}{{A}_{inf}}} . \qquad [ Math14 ]$$

This also allows the digital artifacts to be reduced in order to obtain a more successful image processing.

Thus, during a step 126, the luminous intensity L of the light without having been attenuated by suspended particles is calculated according to the following equation:

$$L = \frac{I - A}{1 - {A}_{n o r m}} . \qquad [ Math15 ]$$

A restored image that no longer has defects or digital artifacts is obtained.

The image processing steps 104-126 of the method 100 according to the invention are carried out independently for each colour channel R, G and B of the acquired image.

The method for underwater imaging according to the present invention can be implemented on an electronic board of the FPGA (Field-Programmable Gate Array) type, for example composed of a Zynq 7020 from Xilinx. Such a board is very compact (70 mm×45 mm) and can be easily mounted on board an ROV, for example.

Since the image processing according to the method of the invention is massively parallelizable, it is possible to retranscribe the processing instructions in VHDL (VHSIC Hardware Description Language; VHSIC meaning Very High Speed Integrated Circuit), which makes it possible to really exploit the potential of the FPGA.

Moreover, it is possible to envisage implementing deep learning solutions in such electronic boards.

Of course, the invention is not limited to the examples that have just been described, and numerous modifications may be made to these examples without exceeding the scope of the invention.

1. A method for underwater imaging, comprising the following steps:
acquiring, by a polarimetric image sensor, an image made up of pixels, the acquired image comprising a backscattered veil for at least a portion of the pixels, the acquired image comprising at least four sub-images (10a, 10b, 10c, 10d), acquired simultaneously, corresponding to at least four different polarizations;
calculating Stokes parameters based on the luminous intensities of the pixels of the acquired image;
determining, based on the Stokes parameters, an angle of polarization of the backscattered veil;
determining, based on the Stokes parameters, a degree of polarization of the backscattered veil;
calculating the luminous intensity of the backscattered veil based on the angle and the degree of polarization of the backscattered veil; and
calculating, based on the acquired image and the luminous intensity of the backscattered veil, an improved image,
the method being implemented by means of a device for underwater imaging.

2. The method according to claim 1, characterized in that the polarizations are linear and correspond to 0°, 45°, 90° and 135°.

3. The method according to claim 1, characterized in that the step of determining an angle of polarization is carried out by:
drawing up a map of angle of polarization values based on the Stokes parameters; and
determining the most represented angle of polarization value, called angle of polarization of the veil, in the acquired image based on the map of angle values.

4. The method according to claim 1, characterized in that the step of determining a degree of polarization is carried out by:
drawing up a map of degree of polarization values based on the Stokes parameters; and
determining the most represented degree of polarization value, called degree of polarization of the veil, in the acquired image based on the map of degree values.

5. The method according to claim 1, characterized in that it also comprises a step of estimating the luminous intensity of the backscattered veil at infinity.

6. The method according to claim 5, characterized in that the step of estimating the luminous intensity of the backscattered veil at infinity is carried out by:
drawing up a map of luminous intensity values based on the angle and the degree of polarization of the backscattered veil; and
determining the most represented intensity value, called luminous intensity to infinity, in the acquired image based on the map of intensity values.

7. The method according to claim 1, characterized in that the step of calculating the luminous intensity of the backscattered veil comprises a step of calculating the average of the luminous intensities of all the sub-images.

8. The method according to claim 1, characterized in that all the image processing steps are carried out independently for each colour channel R, G, and B.

9. A device for underwater imaging comprising:
at least one polarimetric image sensor comprising:
a plurality of elementary sensors;
a matrix of polarization analyzers arranged so that each elementary sensor is equipped with an analyzer, each analyzer being oriented according to one of at least four different polarizations so that the orientations of the analyzers are distributed in a homogeneous manner over the surface of the sensor;
the polarimetric image sensor being configured to acquire an image comprising at least four sub-images, acquired simultaneously, corresponding to the at least four different polarizations; and
an image processing module;
the device being configured to implement the steps of the method according to claim 1.

10. The device according to claim 9, characterized in that it is configured to be adaptable on a remotely operated or autonomous underwater vehicle.

11. A computer program comprising instructions which lead the device for underwater imaging according to claim 9.

12. A computer-readable data medium on which the computer program according to claim 11 is recorded.
